(19) United States
(12) Patent Application Publication
(10) Pub. No.: US 2025/0086773 A1
(43) Pub. Date: Mar. 13, 2025

(54) NON-CONTACT DYNAMIC MEASUREMENT METHOD, SYSTEM, PROCESSING EQUIPMENT AND STORAGE MEDIUM FOR STRUCTURAL DEFORMATION BASED ON SUPER-SENSITIVITY OPTICAL FLOW METHOD

(71) Applicants: Yongchao YANG, Zhejiang (CN); Shanwu LI, Zhejiang (CN)

(72) Inventors: Yongchao YANG, Zhejiang (CN); Shanwu LI, Zhejiang (CN)

(21) Appl. No.: 18/959,706

(22) Filed: Nov. 26, 2024

(30) Foreign Application Priority Data
Oct. 17, 2024 (CN) 2024114485124

(51) Int. Cl. G06T 7/00; G06T 7/20; G06T 7/60

(52) U.S. Cl. CPC G06T 7/0002; G06T 7/20; G06T 7/60; G06T 2207/30184

(57) ABSTRACT

Disclosed are a non-contact dynamic measurement method, system, processing equipment and storage medium for structural deformation based on a super-sensitivity optical flow method. The method includes the following steps: acquiring images of a structure to be measured; calibrating a scale parameter; constructing an original grayscale spatiotemporal matrix of effective pixels by using the pixels with large image grayscale gradients; calculating and identifying structural deformation modes through singular value decomposition, and then constructing a weight matrix based on deformation shapes; performing weighted average filtering on the original grayscale spatiotemporal matrix by using the weight matrix, and restoring decimal parts of grayscale values lost due to digitization by using noise signals during imaging and signal dithering principles; and finally, calculating a pixel displacement time history of each effective pixel point through a gradient-based optical flow method, and converting through the scale parameter to obtain a physical displacement time history.

### TECHNICAL FIELD

The present disclosure relates to a non-contact dynamic measurement method, system, processing equipment and storage medium for structural deformation based on a super-sensitivity optical flow method.

### BACKGROUND OF THE INVENTION

Displacement is one of the key parameters for design and performance evaluation of an engineering structure, and can intuitively reflect the basic performance and state of the structure. Displacement measurement of the prior art is mainly classified into contact displacement measurement and non-contact displacement measurement. Contact displacement measurement devices include displacement meters, inclinometers, levels and the like, but are significantly limited in practical applications due to various reasons. For instance, the displacement meters require fixing brackets, thus bringing troubles in practical applications. Non-contact measurement technologies include GPS, laser radar ranging and the like, which have many defects. For example, GPS measurement features low deflection accuracy, and relatively poor stability in measurement results due to various external factors, such as satellite coverage, weather conditions, and multiple reflection effects. Use of radars requires specific measurement angles, installation of corner reflectors, and professional operation. Laser ranging is limited by a short penetration distance of lasers.

Due to the advantages of low costs and ease of implementation, vision-based image measurement methods are widely applied to displacement measurement. The methods of the prior art mainly include digital image correlation (DIC) and optical flow (OF). The DIC generally requires arrangement of a target with a random speckle pattern on a surface of an object to be measured, and has been widely applied in the field of structural deformation measurement. However, due to the DIC's dependence on targets, the number of spatial measurement points is severely limited by the number of the targets. Moreover, as algorithms entail significant correlation calculations, the DIC features relatively low computational efficiency and can hardly meet the requirements for online measurement at a high sampling rate.

### BRIEF SUMMARY OF THE INVENTION

An objective of the present disclosure is to provide a non-contact dynamic measurement method for structural deformation based on a super-sensitivity optical flow method so as to solve the problems mentioned in the above background art. To achieve the above objective, the present disclosure provides the following technical solution:

The non-contact dynamic measurement method for structural deformation based on a super-sensitivity optical flow method, includes the following steps:
acquiring images of a structure to be measured;
calibrating a scale parameter p according to a physical size of the structure to be measured and the number of pixels in the image;
continuously extracting Nₜ frames of images from the acquired images; for each frame of image, calculating spatial gradient values of all pixels within a framed area, where the spatial gradient values involve two vertical components gₓ and g_{y}, setting a grayscale gradient threshold g_{c}, and selecting the pixels with the spatial gradient values greater than the threshold g_{c} as effective pixels, where the number of the effective pixels is denoted as Nₛ; based on the spatial grayscale values of the effective pixels from the Nₜ frames of images, constructing an effective pixel grayscale spatiotemporal matrix M with a size of Nₜ×Nₛ;
performing singular value decomposition based on the effective pixel grayscale spatiotemporal matrix M, to obtain a left singular matrix U, a singular value diagonal matrix Σ and a right singular matrix V; based on all elements {σᵢ}ᵢ₌₁^{min{N}^{ₛ}^{,N}^{ₜ}^{}} of the singular value diagonal matrix Σ, obtaining total energy E=Σᵢ₌₁^{min{N}^{ₛ}^{,N}^{ₜ}^{}}σᵢ² of all singular values, setting a threshold ratio R_{E} of signal-modal singular value energy to total energy of all singular values, selecting a minimum r value where a ratio

$$R = \frac{{\sum }_{i = 1}^{r} {σ}_{i}^{2}}{E}$$

of energy of preceding r-order singular values in a descending order to total energy of all singular values is greater than the threshold ratio R_{E} as the number of signal modes; based on a matrix Vᵣ composed of preceding r columns of vectors of the right singular matrix V, constructing a weight matrix W=VᵣVᵣ^{T} based on deformation recognition; and
performing weighted average filtering calculation based on the grayscale values of the effective pixels from each frame of image to obtain filtered grayscale values I_{f}=IW of the effective pixels; based on the optical flow method, performing displacement calculation for the filtered grayscale values of the effective pixels from each frame of image to obtain a pixel displacement time history, where a calculation formula is: s(xⱼ, yₖ, t)=(I_{f}⁰(xⱼ, yₖ)−I_{f}(xⱼ, yₖ, t))/|g_{f}⁰|; and based on the scale parameter p and a pixel displacement s, calculating a physical displacement time history d, where a calculation formula is: d=s*p.

Further, the acquiring images of a structure to be measured specifically includes the following sub-steps: setting up a camera on a plane of the structure to be measured, adjusting an angle of view and a focal length of the camera until an imaging plane of the camera overlaps with the plane of the structure to be measured, and turning on the camera to continuously capture images of the structure to be measured.

A physical dimension of the structure to be measured is a horizontal width w of a beam structure, the number of pixels in the image is N_{w}, the scale parameter p is calculated through a formula p=w/N_{w}, the horizontal width w and the corresponding number N_{w} of pixels are measured multiple times in an axial direction of the beam structure, and an average value is taken as a final scale parameter value.

Further, the R_{E} is 95%.

In the present disclosure, a non-contact dynamic measurement system for structural deformation based on a super-sensitivity optical flow method is further provided, including:
an image acquisition module, configured for acquiring images of a structure to be measured;
a scale parameter calibration module, configured for calibrating a scale parameter p according to a physical size of the structure to be measured and the number of pixels in the image;
an effective pixel grayscale spatiotemporal matrix construction module, configured for continuously extracting Nₜ frames of images from the acquired images; for each frame of image, calculating spatial gradient values of all pixels within a framed area, where the spatial gradient values involve two vertical components gₓ and g_{y}, setting a grayscale gradient threshold g_{c}, and selecting the pixels with the spatial gradient values greater than the threshold g_{c} as effective pixels, where the number of the effective pixels is denoted as Nₛ; based on the spatial grayscale values of the effective pixels from the Nₜ frames of images, constructing an effective pixel grayscale spatiotemporal matrix M with a size of Nₜ×Nₛ;
a weight matrix construction module, configured for performing singular value decomposition based on the effective pixel grayscale spatiotemporal matrix M, to obtain a left singular matrix U, a singular value diagonal matrix Σ and a right singular matrix V; based on all elements {σᵢ}ᵢ₌₁^{min{N}^{ₛ}^{,N}^{ₜ}^{}} of the singular value diagonal matrix Σ, obtaining total energy E=Σᵢ₌₁^{min{N}^{ₛ}^{,N}^{ₜ}^{}}σᵢ² of all singular values, setting a threshold ratio R_{E} of signal-modal singular value energy to total energy of all singular values, selecting a minimum r value where a ratio

$$R = \frac{{\sum }_{i = 1}^{r} {σ}_{i}^{2}}{E}$$

of energy of preceding r-order singular values in a descending order to total energy of all singular values is greater than the threshold ratio R_{E} as the number of signal modes; based on a matrix Vᵣ composed of preceding r columns of vectors of the right singular matrix V, constructing a weight matrix W=VᵣVᵣ^{T} based on deformation recognition; and
a physical displacement time history calculation module, configured for performing weighted average filtering calculation based on the grayscale values of the effective pixels from each frame of image to obtain filtered grayscale values I_{f}=IW of the effective pixels; based on the optical flow method, performing displacement calculation for the filtered grayscale values of the effective pixels from each frame of image to obtain a pixel displacement time history, where a calculation formula is: s(xⱼ, yₖ, t)=(I_{f}⁰(xⱼ, yₖ)−I_{f}(xⱼ, yₖ, t))/|g_{f}⁰|; and based on the scale parameter p and a pixel displacement s, calculating a physical displacement time history d, where a calculation formula is: d=s*p.

The present disclosure further provides processing equipment, and the processing equipment includes: a memory and a processor, where the memory stores thereon a computer program executable by the processor, and the processor implements the above non-contact dynamic measurement method for structural deformation based on a super-sensitivity optical flow method when executing the computer program.

The present disclosure further provides a storage medium, where a computer program is stored on the storage medium, and when the computer program is executed by a controller, the above non-contact dynamic measurement method for structural deformation based on a super-sensitivity optical flow method is implemented.

### Beneficial Effects

The present disclosure overcomes the defects of traditional contact structural deformation measurement including lack of spatial measurement points and cumbersome equipment arrangement and image acquisition. Compared with vision-based image measurement methods, the present disclosure does not require arrangement of patterned targets on the structure to be measured, but, by directly utilizing surface texture or edges of the structure, achieves true non-contact full-field dense (high-resolution) measurement.

The super-sensitivity optical flow method provided in the present disclosure breaks through sensitivity limits of image measurement methods, ensures and significantly improves measurement precision relying on fundamental advantages of target-free measurement and high spatial resolutions. The present disclosure is particularly advantageous for remote measurement of large structures. The full-field measurement of large structures raises high requirements for a field of view, and also for measurement precision to achieve very small pixel displacement caused by structural deformation.

A computational process of the method provided in the present disclosure does not involve repetitive correlation calculations but only relates to linear transformation and multi-pixel parallel computation. With high computational efficiency, the method can be used for high-frequency real-time measurement of structural deformation.

### BRIEF DESCRIPTION OF THE DRAWINGS

FIG. 1 is a structural diagram of a testing device of the present disclosure.

FIG. 2 is a diagram of a framed first-frame image of the present disclosure.

FIG. 3 is an example diagram of constructing an effective pixel grayscale spatiotemporal matrix model of the present disclosure.

FIG. 4 is an example diagram of constructing an effective pixel weight matrix model of the present disclosure.

FIG. 5 is an example diagram of a weighted average filtering model of the present disclosure.

FIG. 6 is an example diagram of testing results of the present disclosure.

### DETAILED DESCRIPTION OF THE INVENTION

The technical solutions in the examples of the present disclosure will be clearly and completely described below. Apparently, the described examples are merely some rather than all of the examples of the present disclosure. Based on the examples of the present disclosure, all other examples obtained by those of ordinary skill in the art without making creative efforts shall fall within the protection scope of the present disclosure.

The present disclosure provides a non-contact dynamic measurement method for structural deformation based on a super-sensitivity optical flow method, and the method includes the following steps:

S1: acquire images of a structure to be measured;
specifically including: set up a camera on a plane of the structure to be measured, adjust an angle of view and a focal length of the camera until an imaging plane of the camera overlaps with the plane of the structure to be measured, and turn on the camera to continuously capture images of the structure to be measured;

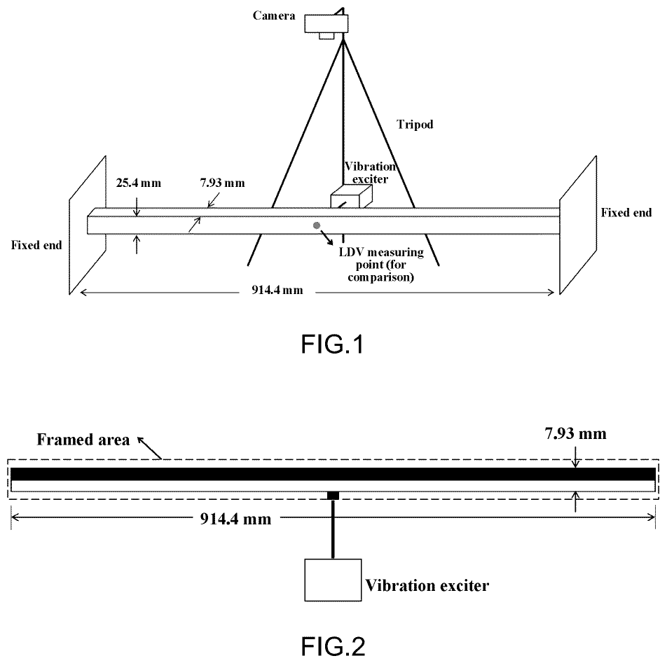

In an example: an object measured is of a beam structure fixed at both ends, an excitation method is adopted, that is, a modal vibration exciter horizontally excites at a mid-span point of the beam structure, and an excitation signal is a harmonic signal (a frequency of 5 Hz). To better illustrate and demonstrate the method of the present disclosure, simple black-and-white striped stickers are pasted on an upper surface of the beam structure (which is not necessary for actual measurement). To measure horizontal deformation and vibration of the beam structure under the horizontal excitation, a video camera is fixed directly above the beam structure through a tripod, and a lens is arranged in a direction of being perpendicular to a horizontal plane. The camera model is SONY PXW-FS5M2, a CMOS imaging chip resolution is 1920×1080 pixels, a focal length of the lens is 24 mm, an acquisition frame rate is 120 frames per second, and an image signal has a bit depth of 8 bits. To verify accuracy of measurement results of the method of the present disclosure, a laser Doppler vibrometer (a high-precision interferometric single-point measurement system, costing nearly a hundred times that of a camera measurement system) is arranged just in front of the beam structure to simultaneously measure horizontal vibration displacement at the mid-span point of the beam structure, as shown in FIG. 1.

S2: calibrate a scale parameter p (unit: mm/pixel) according to a physical size of the structure to be measured and the number of pixels in the image;

In an example: under unloaded conditions, the scale parameter is determined through a formula p=w/N_{w}, according to a horizontal width w of the known beam structure and the number N_{w} of pixels in the image, the horizontal width w and the corresponding number N_{w} of pixels are measured multiple times in an axial direction of the beam structure, and an average value is taken as a final scale parameter value.

S3: continuously extract Nₜ frames of images from the acquired images; for each frame of image, calculate spatial gradient values of all pixels within a framed area, where the spatial gradient values involve two vertical components gₓ and g_{y}, set a grayscale gradient threshold g_{c}, and select the pixels with the spatial gradient values greater than the threshold g_{c} as effective pixels, where the number of the effective pixels is denoted as Nₛ; based on the spatial grayscale values of the effective pixels from the Nₜ frames of images, construct an effective pixel grayscale spatiotemporal matrix M with a size of Nₜ×Nₛ;

S4: perform singular value decomposition based on the effective pixel grayscale spatiotemporal matrix M, to obtain a left singular matrix U, a singular value diagonal matrix Σ and a right singular matrix V; based on all elements {σᵢ}ᵢ₌₁^{min{N}^{ₛ}^{,N}^{ₜ}^{}} of the singular value diagonal matrix Σ, obtain total energy E=Σᵢ₌₁^{min{N}^{ₛ}^{,N}^{ₜ}^{}}σᵢ² of all singular values, set a threshold ratio R_{E} of signal-modal singular value energy to total energy of all singular values, select a minimum r value where a ratio

$$R = \frac{{\sum }_{i = 1}^{r} {σ}_{i}^{2}}{E}$$

of energy of preceding r-order singular values in a descending order to total energy of all singular values is greater than the threshold ratio R_{E} as the number of signal modes; based on a matrix Vᵣ composed of preceding r columns of vectors of the right singular matrix V, construct a weight matrix W=VᵣVᵣ^{T} based on deformation recognition; and

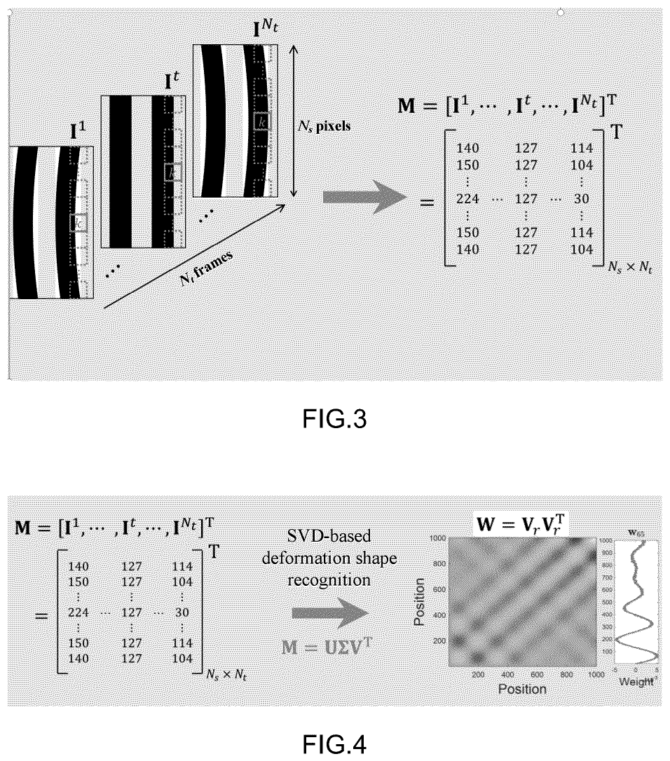

In an example: multiple frames of images continuously captured are imported into a computer, a computation area (as shown in FIG. 2) is framed from a first-frame image, a grayscale gradient of each pixel in the computation area is calculated, the pixels with grayscale gradients greater than the threshold are selected as effective pixels (in this example, referring to the pixels at intersections of black and white stripes) according to a specified threshold, and the grayscale values of the effective pixels in each frame are extracted to form an original grayscale spatiotemporal matrix M of the effective pixels, as shown in FIG. 3; the singular value decomposition of the spatiotemporal matrix is performed, a smallest number of singular modes that meet the condition are selected as signal modes to ensure the proportion to the total energy of all singular values is not less than 95%, the matrix Vᵣ is formed, and the weight matrix W=VᵣVᵣ^{T} is constructed, as shown in FIG. 4.

S5: perform weighted average filtering calculation based on the grayscale values of the effective pixels from each frame of image to obtain filtered grayscale values I_{f}=IW of the effective pixels; based on the optical flow method, perform displacement calculation for the filtered grayscale values of the effective pixels from each frame of image to obtain a pixel displacement time history (unit: pixels), where a calculation formula is: s(xⱼ, yₖ, t)=(I_{f}⁰(xⱼ, yₖ)−I_{f}(xⱼ, yₖ, t)/|g_{f}⁰|, where s represents displacement, xⱼ, yₖ represents position coordinates of a pixel at a j^{th} column and a k^{th} row, t represents time, I_{f}⁰ represents a selected filtered initial-frame image grayscale, I_{f} represents a filtered computed-frame image grayscale, and g_{f}⁰ represents a filtered initial-frame grayscale gradient; and based on the scale parameter p and pixel displacement s, calculate a physical displacement time history d (unit: mm), where a calculation formula is: d=s*p.

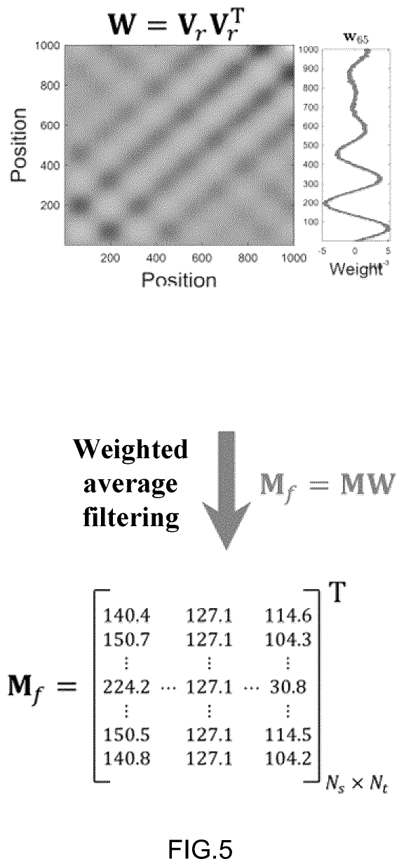

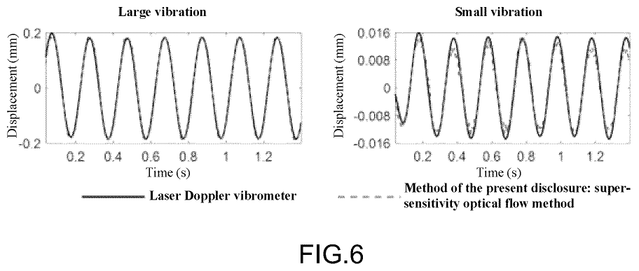

In an example: the weight matrix is used to perform the weighted average filtering calculation of original grayscale values (the weighted average filtering calculation formula is M_{f}=MW), and then grayscale values of original images are replaced with filtered grayscale values to obtain filtered multiple frames of images, as shown in FIG. 5; and the gradient-based optical flow method is used to calculate the displacement of the effective pixels from each frame of image, and finally, calculation results are converted by a physical length unit according to the scale parameter. FIG. 6 illustrates the results of measurement through the method of the present disclosure that are converted by the physical length unit, and comparative results of measurement with a laser Doppler vibrometer. It can be found that under the condition of large vibration with an amplitude of 0.2 mm, the results of measurement through the method of the present disclosure are almost identical to the comparative results of measurement with the laser Doppler vibrometer; and under the condition of small vibration with an amplitude of 0.016 mm, the results of measurement through the method of the present disclosure are generally consistent with the comparative results of measurement with the laser Doppler vibrometer, and the displacement is slightly smaller than that measured by the laser Doppler vibrometer at a peak of vibration.

In the present disclosure, a non-contact dynamic measurement system for structural deformation based on a super-sensitivity optical flow method is further provided, including:
an image acquisition module, configured for acquiring images of a structure to be measured;
a scale parameter calibration module, configured for calibrating a scale parameter p according to a physical size of the structure to be measured and the number of pixels in the image;
an effective pixel grayscale spatiotemporal matrix construction module, configured for continuously extracting Nₜ frames of image from the acquired image; for each frame of image, calculating spatial gradient values of all pixels within a frame-selected area, where the spatial gradient values involve two vertical components gₓ and g_{y}, setting a grayscale gradient threshold g_{c}, and selecting the pixels with the spatial gradient values greater than the threshold g_{c} as effective pixels, where the number of the effective pixels is denoted as Nₛ; based on the spatial grayscale values of the effective pixels from the Nₜ frames of images, constructing an effective pixel grayscale spatiotemporal matrix M with a size of Nₜ×Nₛ;
a weight matrix construction module, configured for performing singular value decomposition based on the effective pixel grayscale spatiotemporal matrix M, to obtain a left singular matrix U, a singular value diagonal matrix Σ and a right singular matrix V; based on all elements {σᵢ}ᵢ₌₁^{min{N}^{ₛ}^{,N}^{ₜ}^{}} of the singular value diagonal matrix Σ, obtaining total energy E=Σᵢ₌₁^{min{N}^{ₛ}^{,N}^{ₜ}^{}}σᵢ² of all singular values, setting a threshold ratio R_{E} of signal-modal singular value energy to total energy of all singular values, selecting a minimum r value where a ratio

$$R = \frac{{\sum }_{i = 1}^{r} {σ}_{i}^{2}}{E}$$

of energy of preceding r-order singular values in a descending order to total energy of all singular values is greater than the threshold ratio R_{E} as the number of signal modes; based on a matrix Vᵣ composed of preceding r columns of vectors of the right singular matrix V, constructing a weight matrix W=VᵣVᵣ^{T} based on deformation recognition; and
a physical displacement time history calculation module, configured for performing weighted average filtering calculation based on the grayscale values of the effective pixels from each frame of image to obtain filtered grayscale values I_{f}=IW of the effective pixels; based on the optical flow method, performing displacement calculation for the filtered grayscale values of the effective pixels from each frame of image to obtain a pixel displacement time history, where a calculation formula is: s(xⱼ, yₖ, t)=(I_{f}⁰(xⱼ, yₖ)−I_{f}(xⱼ, yₖ, t))/|g_{f}⁰|; and based on the scale parameter p and a pixel displacement s, calculating a physical displacement time history d, where a calculation formula is: d=s*p.

The present disclosure further provides processing equipment, and the processing equipment includes: a memory and a processor, where the memory stores thereon a computer program executable by the processor, and the processor implements the above non-contact dynamic measurement method for structural deformation based on a super-sensitivity optical flow method when executing the computer program.

The present disclosure further provides a storage medium, where a computer program is stored on the storage medium, and when the computer program is executed by a controller, the above non-contact dynamic measurement method for structural deformation based on a super-sensitivity optical flow method is implemented.

The foregoing descriptions are merely preferred examples of the present disclosure, and are not intended to impose any formal restrictions on the present disclosure. The protection scope of the present disclosure should be subject to a protection scope of the claims. Although the present disclosure has been disclosed in preferred examples, they are not intended to limit the present disclosure. Without departing from the scope of the technical solution of the present disclosure, any person skilled in the art may make many possible changes to the technical solution by using the above disclosed technical contents, or modify the technical solution into equivalent examples with equivalent changes. Therefore, any simple alterations, equivalent changes and modifications which are made to the above examples in accordance with the technical essence of the present disclosure without departing from the contents of the technical solution of the present disclosure all fall within the scope of protection of the technical solution of the present disclosure.

What is claimed is:

1. A non-contact dynamic measurement method for structural deformation based on a super-sensitivity optical flow method, comprising the following steps:
acquiring images of a structure to be measured;
calibrating a scale parameter p according to a physical size of the structure to be measured and the number of pixels in the image;
continuously extracting Nₜ frames of images from the acquired images; for each frame of image, calculating spatial gradient values of all pixels within a framed area, wherein the spatial gradient values involve two vertical components gₓ and g_{y}, setting a grayscale gradient threshold g_{c}, and selecting the pixels with the spatial gradient values greater than the threshold g_{c} as effective pixels, wherein the number of the effective pixels is denoted as Nₛ; based on the spatial grayscale values of the effective pixels from the Nₜ frames of images, constructing an effective pixel grayscale spatiotemporal matrix M with a size of Nₜ×Nₛ;
performing singular value decomposition based on the effective pixel grayscale spatiotemporal matrix M, to obtain a left singular matrix U, a singular value diagonal matrix Σ and a right singular matrix V; based on all elements {σᵢ}ᵢ₌₁^{min{N}^{ₛ}^{,N}^{ₜ}^{}} of the singular value diagonal matrix Σ, obtaining total energy E=Σᵢ₌₁^{min{N}^{ₛ}^{,N}^{ₜ}^{}}σᵢ² of all singular values, setting a threshold ratio R_{E} of signal-modal singular value energy to total energy of all singular values, selecting a minimum r value wherein a ratio
$$R = \frac{{\sum }_{i = 1}^{r} {σ}_{i}^{2}}{E}$$
of energy of preceding r-order singular values in a descending order to total energy of all singular values is greater than the threshold ratio R_{E} as the number of signal modes; based on a matrix Vᵣ composed of preceding r columns of vectors of the right singular matrix V, constructing a weight matrix W=VᵣVᵣ^{T} based on deformation recognition; and
a physical displacement time history calculation module, being configured for performing weighted average filtering calculation based on the grayscale values of the effective pixels from each frame of image to obtain filtered grayscale values I_{f}=IW of the effective pixels; based on the optical flow method, performing displacement calculation for the filtered grayscale values of the effective pixels from each frame of image to obtain a pixel displacement time history, wherein a calculation formula is: s(xⱼ, yₖ, t)=(I_{f}⁰(xⱼ, yₖ)−I_{f}(xⱼ, yₖ, t))/|g_{f}⁰|; and based on the scale parameter p and a pixel displacement s, calculating a physical displacement time history d, wherein a calculation formula is: d=s*p.

2. The non-contact dynamic measurement method for structural deformation based on a super-sensitivity optical flow method according to claim 1, wherein the acquiring images of a structure to be measured specifically comprises the following sub-steps: setting up a camera on a plane of the structure to be measured, adjusting an angle of view and a focal length of the camera until an imaging plane of the camera overlaps with the plane of the structure to be measured, and turning on the camera to continuously capture images of the structure to be measured.

3. The non-contact dynamic measurement method for structural deformation based on a super-sensitivity optical flow method according to claim 1, wherein a physical dimension of the structure to be measured is a horizontal width w of a beam structure, the number of pixels in the image is N_{w}, the scale parameter p is calculated through a formula p=w/N_{w}, the horizontal width w and the corresponding number N_{w} of pixels are measured multiple times in an axial direction of the beam structure, and an average value is taken as a final scale parameter value.

4. The non-contact dynamic measurement method for structural deformation based on a super-sensitivity optical flow method according to claim 1, wherein the R_{E} is 95%.

5. A non-contact dynamic measurement system for structural deformation based on a super-sensitivity optical flow method, comprising:
an image acquisition module, being configured for acquiring images of a structure to be measured;
a scale parameter calibration module, being configured for calibrating a scale parameter p according to a physical size of the structure to be measured and the number of pixels in the image;
an effective pixel grayscale spatiotemporal matrix construction module, being configured for continuously extracting Nₜ frames of images from the acquired images;
for each frame of image, calculating spatial gradient values of all pixels within a framed area, wherein the spatial gradient values involve two vertical components gₓ and g_{y}, setting a grayscale gradient threshold g_{c}, and selecting the pixels with the spatial gradient values greater than the threshold g_{c} as effective pixels, wherein the number of the effective pixels is denoted as Nₛ; based on the spatial grayscale values of the effective pixels from the Nₜ frames of images, constructing an effective pixel grayscale spatiotemporal matrix M with a size of Nₜ×Nₛ;
a weight matrix construction module, being configured for performing singular value decomposition based on the effective pixel grayscale spatiotemporal matrix M, to obtain a left singular matrix U, a singular value diagonal matrix Σ and a right singular matrix V; based on all elements {σᵢ}ᵢ₌₁^{min{N}^{ₛ}^{,N}^{ₜ}^{}} of the singular value diagonal matrix Σ, obtaining total energy E=Σᵢ₌₁^{min{N}^{ₛ}^{,N}^{ₜ}^{}}σᵢ² of all singular values, setting a threshold ratio R_{E} of signal-modal singular value energy to total energy of all singular values, selecting a minimum r value wherein a ratio
$$R = \frac{{\sum }_{i = 1}^{r} {σ}_{i}^{2}}{E}$$
of energy of preceding r-order singular values in a descending order to total energy of all singular values is greater than the threshold ratio R_{E} as the number of signal modes; based on a matrix Vᵣ composed of preceding r columns of vectors of the right singular matrix V, constructing a weight matrix W=VᵣVᵣ^{T} based on deformation recognition; and
a physical displacement time history calculation module, being configured for performing weighted average filtering calculation based on the grayscale values of the effective pixels from each frame of image to obtain filtered grayscale values I_{f}=IW of the effective pixels; based on the optical flow method, performing displacement calculation for the filtered grayscale values of the effective pixels from each frame of image to obtain a pixel displacement time history, wherein a calculation formula is: s(xⱼ, yₖ, t)=(I_{f}⁰(xⱼ, yₖ)−I_{f}(xⱼ, yₖ, t))/|g_{f}⁰|; and based on the scale parameter p and a pixel displacement s, calculating a physical displacement time history d, wherein a calculation formula is: d=s*p.

6. Processing equipment, comprising: a memory and a processor, wherein the memory stores thereon a computer program executable by the processor, and the processor implements the above non-contact dynamic measurement method for structural deformation based on a super-sensitivity optical flow method according to claim 1 when executing the computer program.

7. A storage medium, wherein a computer program is stored on the storage medium, and when the computer program is executed by a controller, the above non-contact dynamic measurement method for structural deformation based on a super-sensitivity optical flow method according to claim 1 is implemented.
